(19) United States
(12) Patent Application Publication
(10) Pub. No.: US 2017/0337531 A1
(43) Pub. Date: Nov. 23, 2017

(54) SYSTEM AND METHODS FOR SUPPORTING IN-FLIGHT PURCHASE WITH DELIVERY AT DESTINATION AIRPORT

(71) Applicant: MasterCard International Incorporated, Purchase, NY (US)

(72) Inventor: Manoneet Kohli, O'Fallon, MO (US)

(21) Appl. No.: 15/160,339

(22) Filed: May 20, 2016

(51) Int. Cl. G06Q 20/10; G06Q 20/28; G06Q 20/32; G06Q 20/34; G06Q 50/30

(52) U.S. Cl. CPC G06Q 20/102; G06Q 20/3226; G06Q 20/34; G06Q 20/28; G06Q 20/3223; G06Q 50/30

(57) ABSTRACT

A method includes receiving a request for a payment account purchase transaction from a customer. The request indicates at least one item to be purchased. The request includes instructions to deliver the purchased item(s) at an airport. The request further includes flight information concerning an airline flight that the customer is taking or planning to take. The airline flight has the airport as a departure point or as a destination. The method further includes providing a delivery accommodation at the airport to the customer with respect to the purchased item(s).

### BACKGROUND

Payment accounts are in widespread use for both in-store and online purchase transactions. FIG. 1 is a block diagram of a previously proposed version of a payment system (generally indicated by reference numeral 100) as it may operate in connection with an online purchase transaction.

The system 100 includes an e-commerce server computer 102 that may be operated by or on behalf of an online merchant to permit online shopping transactions. For this purpose, as is well known, the e-commerce server computer 102 may host a shopping website, sometimes referred to as an “online store”. A customer 103 who operates a customer device 104 may access the shopping website by communicating over the Internet 105 with the e-commerce server computer 102. As is very well-known to those who are skilled in the art, the customer device 104 may be, for example, a personal computer or notebook computer that runs a browser program, a tablet computer or smartphone that runs a mobile browser and/or a suitable app, etc. As is very familiar to those who shop online, after the customer has selected one or more items of merchandise for purchase from the online store, he/she may elect to enter a checkout phase of the online purchase transaction. In some situations, during the checkout phase, the customer enters payment information, such as a payment account number, expiration date, security code, etc. into an online form. However, according to some proposals, the customer may be presented with an option to select use of the customer's digital wallet, which has been stored in a wallet service provider's computer 106. The digital wallet may contain data relating to several of the customer's payment accounts, and selecting the digital wallet option may result in the customer being presented with the opportunity to select one of those payment accounts for use in the current online purchase transaction. Upon the customer indicating selection of one of the accounts in the digital wallet, the wallet service provider 106 may make the corresponding data (again, payment account number, expiration date, security code, etc.) for the selected account available to the merchant's e-commerce server 102.

In connection with the online purchase transaction, the e-commerce server computer 102 may transmit a transaction authorization request message (sometimes simply referred to as an “authorization request”) to the merchant's acquirer financial institution (“acquirer” or “transaction acquirer”), indicated by reference numeral 110. Assuming that the digital wallet scenario described above had occurred, the authorization request may include the payment data provided from the wallet service provider 106 to the e-commerce server 102.

The acquirer 110 may route the authorization request via a payment network 112 to a server computer 114 operated by the issuer of the payment account that corresponds to the payment data included in the authorization request. Also, the authorization response generated by the issuer server computer 114 may be routed back to the acquirer 110 via the payment network 112. The acquirer 110 may confirm to the merchant (i.e., to the e-commerce server computer 102) that the transaction has been approved.

The payment network 112 may be, for example, the well-known Banknet® system operated by MasterCard International Incorporated, which is the assignee hereof.

The components of the system 100 as depicted in FIG. 1 are only those that are needed for processing a single transaction. Those who are skilled in the art will recognize that in the real world, online shopping and payment systems may process many purchase transactions (including simultaneous transactions) and may include a considerable number of payment account issuers and their computers, a considerable number of acquirers and their computers, and numerous merchants and their e-commerce servers. The system may also include a very large number of customers/online shoppers, who hold payment accounts that they use for their online shopping activities. In some environments there may also be a number of wallet service providers. It is also well known that elements of the system 100 (e.g., acquirers, the payment network, payment account issuers) may play similar roles in connection with in-store purchase transactions and in other types of transactions.

As is well-known, internet access services are often available for purchase on airline flights. Also, airline passengers frequently carry smartphones, tablet computers, or other computing devices with them on board passenger aircraft. With the availability of internet access, devices running browser programs and free time, an airline flight may present a good occasion for the passengers to engage in online shopping transactions. The present inventor has recognized an opportunity to encourage airline passengers to engage in online shopping transactions with merchants that have retail locations at the passengers' destination airports.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional system that handles online purchase transactions.

FIG. 2 is a schematic representation of a payment/online shopping system according to some embodiments.

FIG. 3 schematically illustrates some aspects of an embodiment of the system of FIG. 2.

FIG. 4 is a block diagram representation of a computer that may serve as a component of the system shown in FIGS. 2 and/or 3.

FIG. 5 is a block diagram representation of a typical mobile device such as may be deployed in one or more roles in the system of FIGS. 2 and/or 3.

FIG. 6 is a flow chart that illustrates aspects of the present disclosure.

### DETAILED DESCRIPTION

In general, and for the purpose of introducing concepts of embodiments of the present disclosure, a passenger on an airline flight may engage in an online shopping transaction with a merchant that has a retail store location at the airport to which the airline flight is bound. As part of the transaction, the merchant may receive information about the flight. The merchant may also query the passenger/customer about his/her preferences in terms of facilitating delivery of items purchased in the transaction. The passenger may indicate such a preference to the merchant. The merchant may use the flight information to look up arrival parameters, such as the scheduled arrival gate and estimated time of arrival (ETA). The merchant may facilitate delivery of the purchased item(s) by taking steps such as meeting the passenger at the gate with the items, depositing the items in a locker that is conveniently located relative to the arrival gate, or providing walking directions/mapping to guide the passenger/customer from the arrival gate to the merchant's retail store location in the airport terminal.

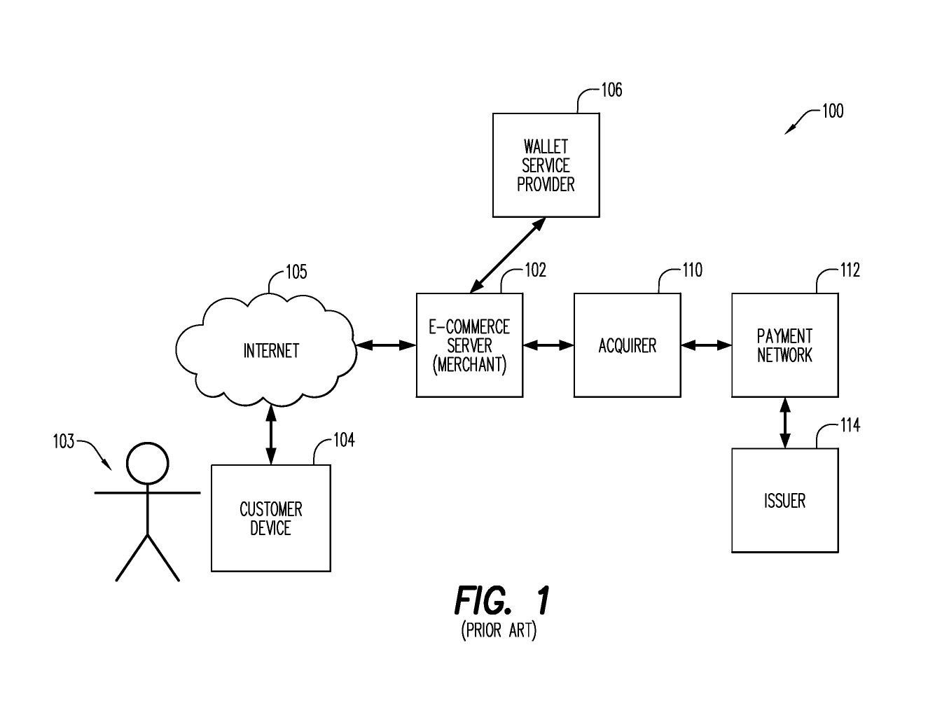

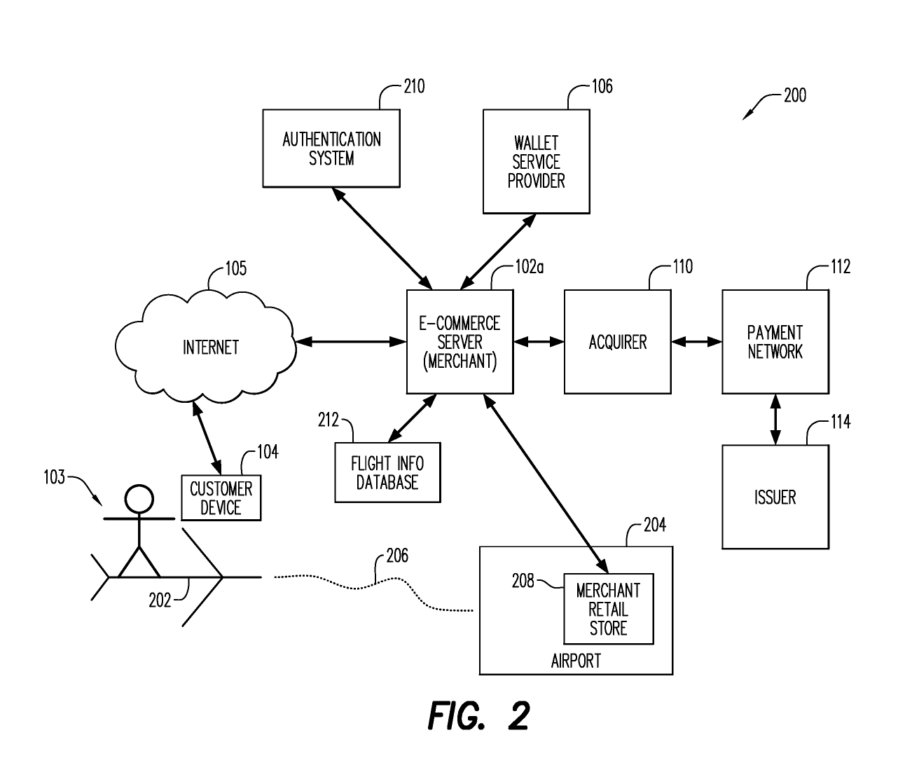

FIG. 2 is a block diagram of a payment/online shopping system 200 provided according to some embodiments. The payment system 200 incorporates—in some form—all of the elements referred to above in connection with FIG. 1. For example, elements/entities 104, 105, 106, 110, 112 and 114 are carried over in the system 200 as depicted in FIG. 2 from the depiction of the system 100 shown in FIG. 1. Further, an element designated by the reference numeral 102a (e-commerce server) in FIG. 2 corresponds to the element designated by reference numeral 102 in FIG. 1. Details of the e-commerce server 102a, as it may be embodied in the system 200, will be described below.

The user 103 is also again shown in FIG. 2, but in this instance is schematically portrayed as being an in-flight passenger on a commercial jet passenger transport aircraft 202. It is noted that the user 103 carries and is using the customer device 104 shown in FIG. 1. The customer device 104 is also shown as being connected to the internet 105 while the passenger/user 103 is aloft on the aircraft 202.

Also schematically shown in FIG. 2 is an airport 204 toward which the aircraft 202 is bound via a planned flight path (represented by dotted line curve 206). It will also be noted that a retail store 208 is schematically shown located at the airport 204. The retail store 208 is owned or affiliated with the merchant that operates the e-commerce server 102a or is represented through the e-commerce server 102a.

According to aspects of the present disclosure, the system 200 also includes an authentication system 210. The authentication system 210 may provide guidance to merchants (including the operator of the e-commerce server 102a, or merchants represented by the e-commerce server 102a) as to the degree of risk involved in online shopping or other transactions.

FIG. 2 also shows a flight information database 212. The flight information database 212 may be accessed by the e-commerce server 102a as a resource to aid in providing at-airport delivery of items purchased online from the merchant. The flight information database 212 may be updated regularly and frequently with flight information such as flight status, estimated time of arrival, and scheduled or actual arrival gate.

To discuss the subject matter of FIG. 2 more generally, it should be understood that in most cases, blocks labeled therein with names/descriptions of entities should also be understood to represent computer systems operated by or for such entities.

It should also be understood that, for at least some types of participants in the payment system 200, there may be a considerable or even a very large number of participants of those types in practical embodiments of the payment system 200. Moreover, one or more components of the payment system 200 may handle in-store purchase transactions and/or other types of transactions in addition to online purchase transactions.

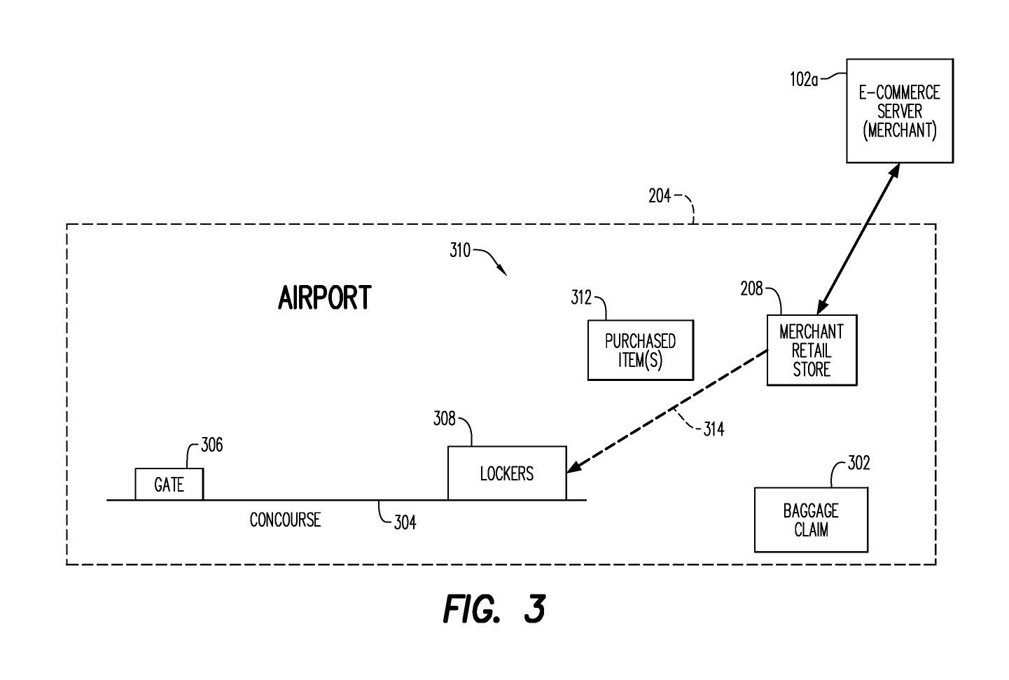

FIG. 3 schematically illustrates some aspects of an embodiment of the system 200 of FIG. 2.

FIG. 3 shows the same e-commerce server 102a and merchant retail store 208 as were referred to above in connection with FIG. 2. Moreover, FIG. 3 also shows the same airport 204; with the latter schematically represented by a dotted line box in FIG. 3.

The airport baggage claim (or one of them) is represented at 302 in FIG. 3. An airport terminal concourse is schematically represented at 304. (It will be appreciated that the airport 204 may have more than one concourse, as is generally the case at a major airport.) The concourse is lined with gates from which passengers may board aircraft or deplane, depending on whether the flight in question is departing or arriving. Of such gates only one is shown in FIG. 3, and is indicated by references numeral 306. For purposes of this particular embodiment, it may be assumed that the gate 306 is the planned arrival gate for the passenger aircraft 202 shown in FIG. 2 (not shown in FIG. 3).

Reference numeral 308 indicates a block that schematically represents a group of lockers that may be employed, in connection with aspects of the present disclosure, to aid in facilitating at-airport delivery of items purchased during in-flight online shopping sessions. In some embodiments, the lockers 308 may be located at or near the terminal end (proximal end) of the concourse 304. In other words, the lockers 308 may be located such that they would be passed by all passengers deplaning or boarding at concourse 304, as the passengers walk to or from the terminal proper (not separately shown) and/or toward the baggage claim 302.

In some situations, as schematically represented at 310, an employee of the merchant retail store 208 may facilitate at-airport delivery of a purchased item 312 by carrying the purchased item 312 to transport the purchased item on a route 314 from the retail store 208 to the lockers 308 to deposit the purchased item in one of the lockers to await pickup by the purchaser soon to deplane into concourse 304.

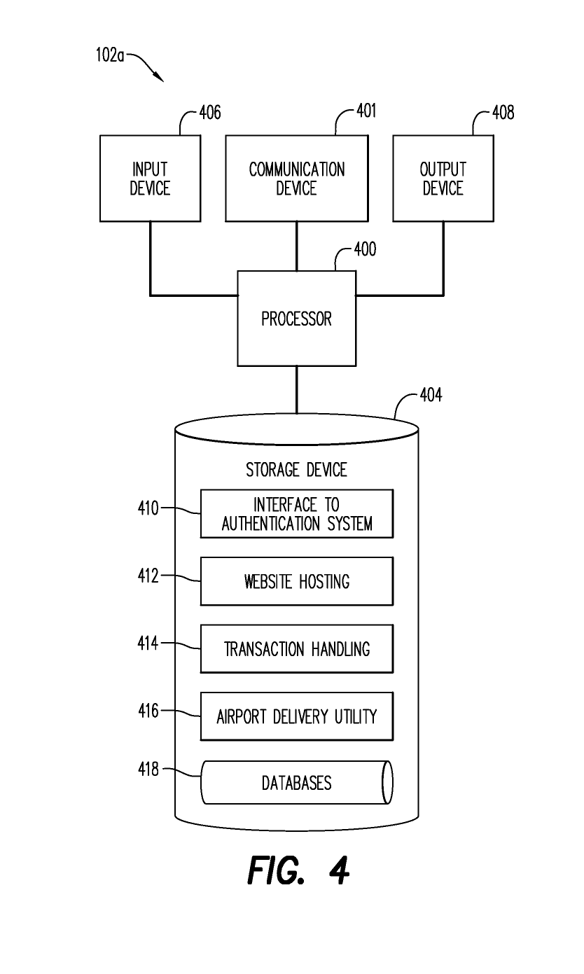

FIG. 4 is a block diagram representation of an embodiment of the e-commerce server 102a.

In some embodiments, hardware aspects of the e-commerce server 102a may be constituted by typical server computer hardware, but may be controlled by software to cause it to function as described herein.

The e-commerce server 102a may include a processor 400 operatively coupled to a communication device 401, a storage device 404, an input device 406 and an output device 408. The communication device 401, the storage device 404, the input device 406 and the output device 408 may all be in communication with the processor 400.

The processor 400 may be constituted by one or more processors. The processor 400 may operate to execute processor-executable steps, contained in program instructions described below, so as to control the e-commerce server 102a to provide desired functionality.

Communication device 401 may be used to facilitate communication with, for example, other devices (such as numerous customer devices). For example, communication device 401 may comprise numerous communication ports (not separately shown), to allow the e-commerce server 102a to handle numerous simultaneous online purchase transactions.

Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 404 stores one or more programs for controlling processor 400. The programs comprise program instructions (which may be referred to as computer readable program code means) that contain processor-executable process steps of the e-commerce server 102a, executed by the processor 400 to cause the e-commerce server 102a to function as described herein.

The programs may include one or more conventional operating systems (not shown) that control the processor 400 so as to manage and coordinate activities and sharing of resources in the e-commerce server 102a, and to serve as a host for application programs (described below) that run on the e-commerce server 102a.

The programs stored in the storage device 404 may also include a software interface 410 that controls the processor 400 to support communication between the e-commerce server 102a and the authentication system 210.

Further, the storage device 404 may store a website hosting program 412 that enables the e-commerce server 102a to make an online shopping website available to online shopping customers. In some embodiments, the website hosting program 412 may provide functionality such as is typically provided in connection with hosting of online shopping websites.

Still further, the storage device may store a transaction handling program 414. The transaction handling program 414 may program the processor 400 such that the e-commerce server 102a is enabled to handle online purchase transactions engaged in by visitors to the merchant's online shopping website. In some embodiments, the capabilities of the transaction handling program 414 may be such as are typically found in connection with handling of online purchase transactions, but with suitable modifications, as described below, to support additional functionality in accordance with aspects of the present disclosure.

In addition, the storage device 404 may store an airport delivery utility program 416. The airport delivery utility program 416 may cooperate with the transaction handling program 414 to aid in facilitating at-airport delivery of purchased items in a manner as described herein.

The storage device 404 may also store, and the e-commerce server 102a may also execute, other programs, which are not shown. For example, such programs may include a reporting application, which may respond to requests from system administrators for reports on the activities performed by the e-commerce server 102a. The other programs may also include, e.g., device drivers, database management programs, communications software, etc.

The storage device 404 may also store one or more databases 418 that may be required for operation of the e-commerce server 102a.

In some embodiments, the e-commerce server 102a may host an online shopping marketplace that is entirely dedicated to products offered by merchant retail stores at a particular airport or airport terminal. In other words, the online shopping site hosted by the e-commerce server 102a may be a catalog site in that it offers products available from a number of different merchants that may not be under common ownership.

Other computer components of the system 200 (FIG. 2) may also have the same type of hardware architecture and/or components as described above in connection with FIG. 4, and may be suitably programmed for the respective roles of those computer components.

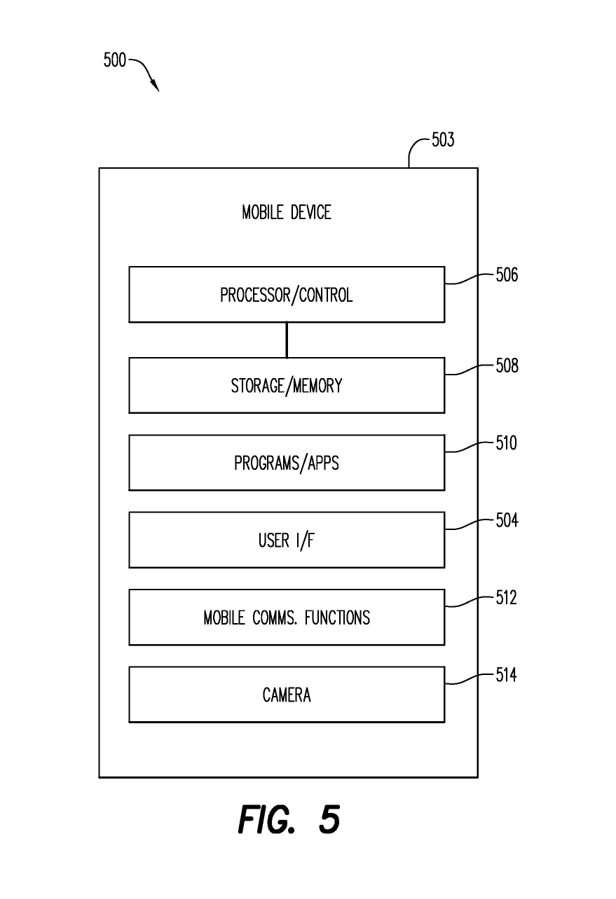

FIG. 5 is a block diagram of a typical embodiment of a mobile device 500, such as may be employed in one or more roles in the system 200 of FIG. 2. For example, a device similar to mobile device 500 may serve as the customer device 104 shown in FIG. 2. As will also be seen, in some embodiments a device like the mobile device 500 may be carried and used by an employee of the retail store 208 (FIG. 2) to aid in operations related to in-airport delivery of purchased items. For purposes of the ensuing discussion, it is assumed (though this assumption should not be taken to be limiting), that the mobile device 500 is embodied as a smartphone.

Continuing to refer to FIG. 5, the mobile device 500 may include a housing 503. In many embodiments, the front of the housing 503 is predominantly constituted by a touchscreen (not separately shown), which is a key element of the user interface 504 of the mobile device 500.

The mobile device 500 further includes a mobile processor/control circuit 506, which is contained within the housing 503. Also included in the mobile device 500 is a storage/memory device or devices (reference numeral 508). The storage/memory devices 508 are in communication with the processor/control circuit 506 and may contain program instructions to control the processor/control circuit 506 to manage and perform various functions of the mobile device 500. As is well-known, a device such as mobile device 500 may function as what is in effect a pocket-sized personal computer (assuming for example that the mobile device is a smartphone), via programming with a number of application programs, or “apps”, as well as a mobile operating system (OS). (The apps are represented at block 510 in FIG. 5, and may, along with other programs, in practice be stored in block 508, to program the processor/control circuit 506.)

As is typical for mobile devices, the mobile device 500 may include mobile and/or other communication functions as represented by block 512. The communication functions 512 may include voice and data communication via a mobile communication network (not shown) with which the mobile device 500 is registered. It should also be understood that the communication capabilities included in the communication functions 512 may also include relatively short-range communication capabilities such as communication in accordance with the well-known WiFi standard. For example, WiFi communication may be utilized to connect the mobile device 500 to a communication system in the passenger cabin of the aircraft 202 (FIG. 2) for connection to the internet 105. It will be appreciated that a suitable antenna and transceiver arrangement (both not separately shown) may be included in the mobile device 500 to support WiFi communication.

Although also not separately shown in FIG. 5, it should be understood that the communication functions 512 may include hardware aspects such as a microphone, a speaker, an antenna, a transceiver circuit, etc., all supported in and/or on the housing 503, for communication via a mobile communication network.

Further, as is shown at block 514, and as is common in smartphones, the mobile device 500 may also include a conventional digital camera. The camera 514 may be operable by the user 103 to capture images that may be stored in the mobile device 500 and/or transmitted to another device from the mobile device 500 via data communication.

From the foregoing discussion, it will be appreciated that the blocks depicted in FIG. 5 as components of the mobile device 500 may in effect overlap with each other, and/or there may be functional connections among the blocks which are not explicitly shown in the drawing. It may also be assumed that, like a typical smartphone, the mobile device 500 may include a rechargeable battery (not shown) that is contained within the housing 503 and that provides electrical power to the active components of the mobile device 500.

It has been posited that the mobile device 500 may be embodied as a smartphone, but this assumption is not intended to be limiting, as mobile device 500 may alternatively, in at least some cases, be constituted by a tablet computer. Moreover, other devices, such as laptop computers, or other types of portable digital devices may play the role of the customer device 104 shown in FIG. 2.

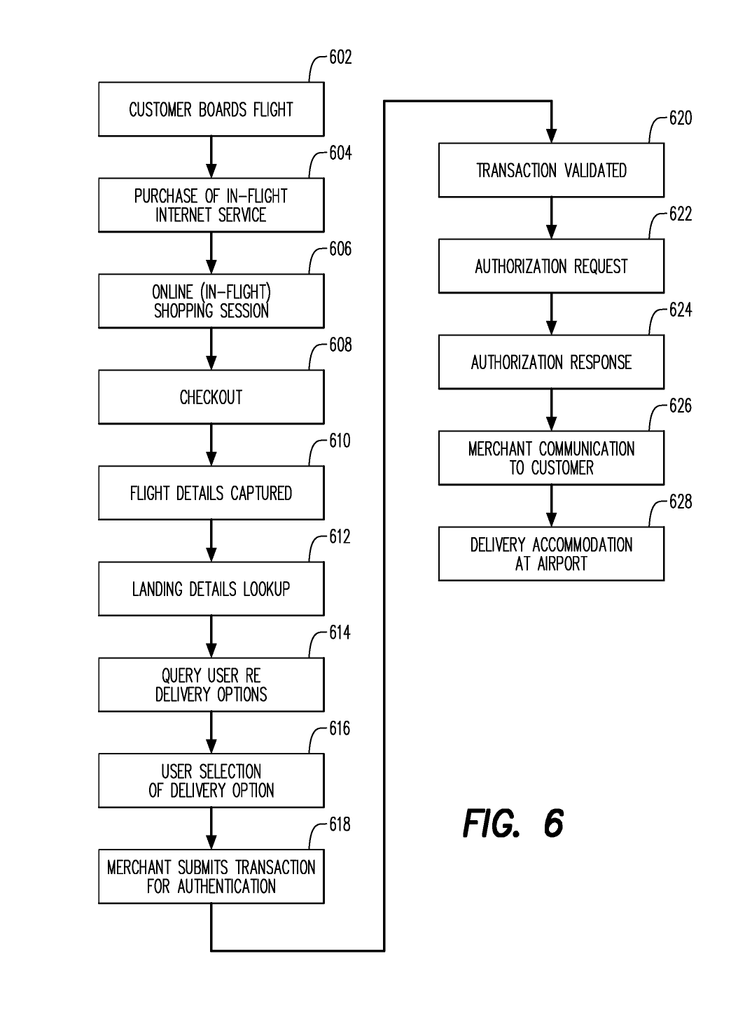

FIG. 6 is a flow chart that illustrates aspects of the present disclosure.

At block 602, the passenger/user (reference numeral 103 in FIG. 2) boards the aircraft 202. The passenger is carrying the customer device 104 with him/her. The aircraft 202 is equipped to provide internet access via WiFi to WiFi-equipped devices in the passenger cabin (e.g., the customer device 104). For example, internet access may be an optional feature for which the passenger is required to pay an additional fee. Block 604 represents purchase of internet access by the passenger. This may occur after the passenger boards the aircraft 202 or may have been arranged via pre-purchase. (As with many process steps described herein, the order of steps 602 and 604 may vary from the order indicated in the drawing.)

At block 606, the passenger/user 103 engages in an online shopping session. That is, the passenger/user 103 employs the customer device 104 to access the e-commerce server 102a via the internet 105. This may occur, for example, while the aircraft 202 is aloft, in flight and bound for the destination airport 204. For example, a paper catalog or brochure available at the user's seat on the aircraft may contain a QR code that the user scans with the customer device 104 to cause the customer device 104 to initiate the shopping session.

For present purposes, it is assumed that the e-commerce server 102a presents to the user 103 a catalog of items available for delivery at or via the merchant's retail store location 208 at the destination airport 204. (In some embodiments, the e-commerce server may offer products available from a number or different stores (not shown) at the destination airport 204. The e-commerce server 102a may, in some embodiments, also offer other items not available for delivery at the destination airport 204.) It is further assumed that the user 103 selects for purchase one or more items from the catalog; the selected items are assumed to be available at the retail store 208. Upon completing selection of the items to be purchased, the user 103a selects the checkout phase (block 608) of the online shopping session.

In some embodiments, the shopping session and/or checkout may involve launching and/or using a browser program on the customer device 104 to access the e-commerce server 102a. Alternatively, the shopping/checkout may be performed “in-app” on the customer device 104 via a merchant-specific app that runs on the customer device 104. In some embodiments, the shopping and selection of an item may be “collapsed” into scanning a QR code in an in-flight hard-copy magazine advertisement to indicate/initiate selection of a particular item illustrated in the in-flight magazine advertisement as available at the destination airport.

At block 610, details concerning the airline flight that the user is currently on may be captured for use by the merchant. For example, this process may be undertaken or enabled by a wallet app in the customer device 103 and/or by a merchant app that interacts with the customer device 104. For example, assuming the customer device 104 is a smartphone, the user 103 may use the camera 514 of the customer device 104 to capture an image of the user's boarding pass. The digital image of the boarding pass may be analyzed (subjected to character recognition) to capture the flight information. The flight information captured may be the airline and the flight number for the flight on which the user 103 is a passenger. In some embodiments, or in some situations, where the customer device stores a “soft” (i.e., machine readable data file) version of the boarding pass, that file may be transmitted to the merchant. As another alternative, the user may be requested to manually input the airline/flight number into the customer device 104 for uploading to the e-commerce server 102a or other computer that is coordinating delivery logistics. In some embodiments, the flight information may be captured automatically as a result of binding a particular soft copy of the catalog—presented to the user—with the specific flight/seat number occupied by the user.

At block 612, the merchant, or a coordinating/cooperative party, may use the flight information to look up and validate the destination of the flight and the expected time of arrival of the flight at the destination airport 204, as well as the expected landing gate. Assuming this validation of destination/landing information is successful, the process may move forward to block 614. At block 614, the merchant may query the user 103 (via the customer device 104) as to the user's preference concerning how delivery of the purchased items is to be accomplished. The options presented to the user may include: (a) delivery/pickup of the items at the retail store location 208 in the terminal of the destination airport; (b) delivery to the user at the arrival gate (reference numeral 306, FIG. 3) for the flight at the destination airport 204; (c) (if the user is changing planes at the destination airport) delivery to the user at the departure gate (not specifically shown) for the user's connecting flight departing from the destination airport 204; or (d) deposit of the selected item(s) in a locker (reference numeral 308, FIG. 3) that will be conveniently accessible to the user 103 after the user deplanes at the destination airport 204.

At block 616, the user selects one of the delivery options offered at 614, and the merchant receives a signal indicating the user's delivery option selection. Details of implementation of the delivery options will be provided below.

At block 618, the merchant submits the transaction to the authentication system 210. The purpose of this activity is to obtain guidance from the authentication system as to the degree of risk associated with the transaction.

At block 620, the authentication system 210 (FIG. 2) may validate the transaction. That is, for example, on determining that the transaction is one in which delivery is to occur at an airport terminal, the authentication system 210 may conclude that the transaction is low-risk, in view of the controls on access to the terminal environment. Moreover, the validation of the transaction by the authentication system 210 may include the authentication system looking up and validating the flight itinerary of the user 103. In connection with validation of the transaction, the authentication system 210 may provide an authentication code to the e-commerce server 102a.

At block 622, the merchant/e-commerce server 102a may receive the authentication code from the authentication system 210, and then may proceed to generate and transmit a transaction authorization request message for the transaction. The authorization request may include the authentication code received from the authentication system 210, and may be routed to the payment account issuer 114 (FIG. 2), via the transaction acquirer 110 and the payment network 112.

At block 624, the account issuer 114 may generate an authorization response for the transaction. Before doing so, and in addition to checking the status and available balance for the user's payment account, the account issuer 114 may perform other activities to assure itself that there is little likelihood that the transaction is fraudulent. These other activities may include sending an inquiry to a fraud detection/prevention service offered by the operator of the payment network 112. That service may confirm the context for the purchase, including the geographic location for the user 103 and/or for the merchant retail store 208, the transaction amount/currency applicable to the transaction, validation of the user's boarding pass and/or that the name on the boarding pass matches the name on the payment account, the user's transaction history and/or the user's travel history.

Assuming that the checks performed by the account issuer 114 and/or the fraud service do not reveal any concerns, the authorization response may indicate that the issuer 114 has approved the transaction. The authorization response may be routed from the issuer 114 to the merchant/e-commerce server 102a via the payment system 112 and the transaction acquirer 110.

Assuming, again, approval of the transaction, the merchant/e-commerce server 102a may (at block 626) communicate to the user 103, via the customer device 104, that the transaction has been approved. In the same communication, the merchant may confirm the delivery arrangement as selected by the user, and may indicate to the user what the user will need to do to authenticate himself/herself at the time of delivery. For example, the user's self-authentication on delivery may involve presenting his/her boarding pass and/or presenting a payment account card that matches the payment account used for the transaction, or a passcode/password included in the communication from the merchant. The specific location at which delivery will occur and the specific user authentication/identification process to occur at the destination airport may be stated and confirmed in detail in the communication from the merchant to the customer at step 626.

At block 628, delivery of the purchased items occurs at the destination airport in the manner selected by the user at 618. In accordance with aspects of the present disclosure, the merchant may facilitate the delivery in one or more of the manners described below.

The delivery accommodation may be triggered, and the retail store 208 notified that the purchase has occurred and will be consummated through the retail store, via a communication from the e-commerce server 102a. For example, the e-commerce server may send a text-message or a suitable in-app message to a mobile device (not separately shown in FIG. 3) carried by a delivery manager employee at the retail store 208. The message (or a page to which the message links) may provide details to the retail store 208 concerning what item(s) was (were) purchased and how and when and to whom they are to be delivered.

If the user elected to pick up the items at the merchant's retail store location, then the merchant may facilitate delivery by providing a walking map/directions to the user to guide the user from the user's arrival gate to the retail store. In some embodiments, this map may be sent during the transaction, and may be based on the currently planned arrival gate for the user's flight. In other embodiments, for example, the merchant may track the flight information available from the airline for the user's flight, and may obtain notification in real time of the flight's arrival, and confirmation of the actual gate at which deplaning occurs. On receiving this information, the merchant may send a text message to the user's customer device 104 containing a link to the map/directions to guide the user to the merchant's retail store location. Once the user arrives at the store location, he/she may identify himself/herself, present the required identification verification (boarding pass, payment account card, passcode, etc.) and receive possession of the purchased item. At the same time, the user may browse the merchant's retail store location for possible additional items to purchase.

If the user elected delivery at the arrival gate, then the merchant may track the flight's ETA and confirm/update the actual gate used for deplaning, and may do so in time to dispatch an employee or messenger with the purchased items to meet the passenger/user at the arrival gate. The employee/messenger may hold up a sign/digital display with the passenger/user's name. The merchant's name/logo may also be displayed. Again, the user provides the required identification verification, and receives delivery of the purchased items at the arrival gate.

If the user elected delivery at the departure gate for his/her connecting flight, a similar process may be followed as per the preceding paragraph. The procedure may be supplemented with an exchange of text messages between the merchant/employee/messenger and the user to confirm the user's presence at the departure gate. A telephone conversation with the user may also be employed for this purpose, and perhaps to arrange an immediate meeting at the airline clerk's desk for the departure gate.

If the user has elected to pick up the purchased items from a locker, then the merchant may select a locker location (and a specific locker at that location) based on the concourse where the user's aircraft will arrive/has arrived for deplaning. The locker system may be computerized to inform the merchant as to which lockers are not currently in use. The merchant may dispatch an employee/messenger with the purchased items to deposit the items in the selected locker. Video surveillance of the lockers may show to the merchant's delivery manager that the items were duly deposited in the locker. The computer component of the locker system may confirm to the merchant that the locker door has been secured closed. The locker system may also provide to the merchant a one-time combination code for opening the locker to pick up the purchased items. The merchant may communicate the locker number and location (including walking directions/map from the arrival gate to the locker) plus the combination code to the user via, e.g., a link supplied in a text message. The user may be guided from his/her arrival gate to the locker and may enter the combination code (via a keypad or virtual keypad on the locker) to open the locker and pick up the purchased items. This approach may have the advantage of not requiring the logistics involved in a face-to-face meeting between the passenger/purchaser/user and the store employee/messenger.

At an alternative to opening the locker via a combination code, the locker may feature a magnetic stripe card reader component (or other type of card reader), and may be programmed to recognize the user's payment account number when the user swipes (or presents) his/her payment account card through the reader component. Thus the user's payment account card may be presented to the locker to access the purchased items. As another alternative, the locker may feature a digital camera. The purchaser/user may present his/her boarding pass to the camera for reading/parsing by the locker to identify the purchaser/user to the locker. Alternatively, the merchant may, in some embodiments, transmit the pick-up credentials to the customer in the form of a barcode or QR code. In such a case, the barcode/QR code may be displayed on the display component of the customer's mobile device and may be read by an optical scanner at the locker to grant access to the purchased item(s).

In some embodiments, the passenger/user may be permitted to identify himself/herself for delivery of the purchased items by presenting other documents, such as a passport or driver's license or other photo identification card. In some embodiments, the passenger/user may be identified by a biometric measure. For example, the merchant may request the authentication system 210 to issue a biometric challenge to the user via the customer device 104. The merchant may release the purchased items to the user upon receiving confirmation from the authentication system 210 that the user successfully completed the biometric challenge.

In embodiments/situations described above, the online shopping session leading to a purchase transaction occurred while the passenger was aloft in the aircraft en route to the destination airport. Alternatively, for example, the shopping session may occur at other times, such as (1) while the user is waiting to board the flight at the departure gate at the airport (not shown) from which the flight originates; (2) while the user is traveling to the departure airport to board the flight; (3) while the user is at home before traveling to the airport; or (4) at other times or locations prior to the user boarding the flight.

With the delivery arrangements as described herein, the teachings of the present disclosure may encourage increased online shopping with merchants who have a presence at airport terminals, and may lead to improved convenience for air travelers in their shopping experience with merchants located at airports.

As used herein and in the appended claims, the term “providing a delivery accommodation” refers to at least one of: (a) providing a map and/or walking directions to guide a customer from an airport arrival gate to a location where purchased goods are to be received or obtained; (b) personally delivering purchased goods to a customer at an arrival gate at an airport; (c) personally delivering purchased goods to a customer at a departure gate at an airport; and (d) depositing purchased goods in a locker for pickup by a customer.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” (or “payment account system”) refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving a request for a payment account purchase transaction from a customer, the request indicating at least one item to be purchased, the request including instructions to deliver the at least one item at an airport, the request also including flight information concerning an airline flight that the customer is taking or plans to take, said airline flight having said airport as a departure point or as a destination; and
providing a delivery accommodation at the airport to the customer with respect to the at least one item.

2. The method of claim 1, wherein the request is received by a merchant having a retail store location at the airport.

3. The method of claim 2, wherein the delivery accommodation includes transmitting, to a mobile device used by the customer, walking directions for walking from a flight arrival gate at the airport to the merchant's retail store location.

4. The method of claim 2, wherein the delivery accommodation includes delivering the at least one item to the customer at a flight arrival or departure gate at the airport.

5. The method of claim 2, wherein the delivery accommodation includes depositing the at least one item in a locker at the airport.

6. The method of claim 1, wherein the flight information includes an image of the customer's boarding pass for the airline flight.

7. The method of claim 1, wherein the flight information includes the boarding pass for the airline flight as a machine-readable digital file.

8. The method of claim 1, further comprising:
requiring the customer to present a credential upon delivery of the at least one item.

9. The method of claim 8, wherein the credential is the customer's boarding pass for the airline flight.

10. The method of claim 8, wherein the credential is a payment account card issued in connection with a payment account used for the payment account transaction.

11. The method of claim 10, wherein the payment account card is presented by submitting the payment account card to a card reader component of a locker in which the at least one item has been deposited.

12. The method of claim 8, wherein the credential is an alphanumeric code or password.

13. The method of claim 12, wherein the credential is presented by inputting it into a keypad component of a locker in which the at least one item has been deposited.

14. The method of claim 8, wherein the credential is presented in the form of a barcode or QR code displayed on the customer's mobile device.

15. The method of claim 1, wherein the request is received at a time when the customer is in transit on the airline flight.

16. The method of claim 1, wherein the request is received at a time when the customer is waiting to board the airline flight.

17. A method comprising:
receiving a request for a payment account purchase transaction, the request originating from a mobile device operated by a customer while the customer is aloft on board an airline flight, the airline flight scheduled to land at a destination airport, the request received by a merchant having a retail store location at the destination airport, the purchase transaction related to at least one item selected for purchase from the merchant by the customer;
depositing the at least one item in a locker located in a concourse at the destination airport, the airline flight scheduled to deplane at a gate in said concourse; and
transmitting, to the mobile device, information that identifies said locker, said transmitting occurring while the customer is aloft on board the airline flight.

18. The method of claim 17, wherein the receiving step includes receiving information that identifies the airline flight.

19. The method of claim 18, further comprising:
selecting said locker based at least in part on the received information that identifies the airline flight.

20. The method of claim 19, wherein said selecting includes determining an airport terminal gate at which the airline flight is scheduled to deplane.

21. An apparatus comprising:
a processor; and
a memory in communication with the processor, the memory storing program instructions, the processor operative with the program instructions to perform functions as follows:
receiving a request for a payment account purchase transaction from a customer, the request indicating at least one item to be purchased, the request including instructions to deliver the at least one item at an airport, the request also including flight information concerning an airline flight that the customer is taking or plans to take, said airline flight having said airport as a departure point or as a destination; and
providing a delivery accommodation at the airport to the customer with respect to the at least one item.
